(19) United States
(12) Patent Application Publication
(10) Pub. No.: US 2011/0039671 A1
(43) Pub. Date: Feb. 17, 2011

(54) ROLLER STRUCTURE OF A BUSINESS MACHINE

(76) Inventor: Chih Huang CHOU, Taipei County (TW)

Correspondence Address: RABIN & Berdo, PC, 1101 14TH STREET, NW, SUITE 500, WASHINGTON, DC, 20005, US

(21) Appl. No.: 12/699,219

(22) Filed: Feb. 3, 2010

(30) Foreign Application Priority Data
Aug. 11, 2009 (TW) 098214795

(51) Int. Cl. A01B 29/00

(52) U.S. Cl. 492/28

(57) ABSTRACT

This present invention relates to a roller structure of a business machine, including a roller and a shaft, by which a plurality of intersecting grooves are provided on the friction surface of the roller so as to form a plurality of contact areas simultaneously on the outer surface in the lateral direction along the roller during the whole rotating process, and the shaft, driving the roller, is correspondingly installed through the insertion passage located at the center of its cylindrical structure of the roller, so as to enable feeding and aligning the paper more silently and stably with a better friction force, to accommodate the dirt or paper dust generated, and thus enhancing the life expectancy of the roller parts.

### CROSS-REFERENCE TO RELATED APPLICATIONS

This non-provisional application claims priority under 35 U.S.C. §119(a) on Patent Application No(s). 098214795 filed in Taiwan, R.O.C. on Aug. 11, 2009, the entire contents of which are hereby incorporated by reference.

### BACKGROUND OF THE INVENTION

### Prior Art

Accordingly, a prior application of a roller structure of a business machine (shown in FIG. 1) primarily consists of a roller 30 and a shaft 40, which the roller 30 is configured by a direct and complete touching with the paper to be printed. Initially, it might provide a practical frictional function for paper feeding. However, after a period of use, there will be more and more feeding errors or paper jams occurring during the process of operation due to lowered friction which results from the accumulation of dust or tiny paper pieces. There is another prior roller structure of a business machine (shown in FIG. 2) mainly consisting of a roller 50 and a shaft 60, wherein the roller 50 is configured with a plurality of lateral grooves, parallel to the shaft, with the same length of the roller structure. When the lateral grooves are formed with a shallow depth, the dust and those tiny paper pieces could easily fill in those grooves. On the other hand, when the lateral grooves are formed with a deeper depth, there is more vibration and noise during the rotation of the roller. Besides, the lateral groves, there are also a number of friction gaps between the roller and the paper, which cause frequent paper jams and feeding with poor alignment. There is another prior roller structure of a business machine (not shown) configured with a rough roller surface which generates more dust and tiny paper pieces. These prior roller structure types have many shortcomings to overcome.

### SUMMARY OF THE INVENTION

The main purpose of the present invention is to provide a roller structure of a business machine, including a roller and a shaft, by which a plurality of intersecting grooves are provided on the friction surface of the roller so as to form a plurality of contact areas simultaneously on the outer surface in the lateral direction along the roller during the whole rotating process, and the shaft, driving the roller, is correspondingly installed through the insertion passage located at the center of its cylindrical structure of the roller. With the intersecting distribution of grooves, it creates near diamond-shaped contact area without any friction gap to provide a silent, stable and speedy feeding free from paper slipping and jamming. Above all, the present invention can provide a longer life expectancy of the roller parts.

Another purpose of the present invention is to provide a roller structure of a business machine, including a roller and a shaft, by which a plurality of grooves around the circumference of the roller are randomly established section by section in a direction parallel to the shaft on the outer surface of the roller. Also, the roller can be divided into a number of slices in accordance with the length of grooves before assembly of the whole roller structure.

To achieve above-mentioned purposes, the present invention provides a roller structure of a business machine, including a roller and a shaft. With this configuration, a plurality of grooves around the circumference of the roller can provide a longer service period of the roller parts and can reduce those operational inconveniences caused by friction gap, dust, tiny paper pieces, rotational vibration and running noise.

To enable a further understanding of the said objectives and the technological methods of the invention herein, the brief description of the drawings below is followed by the detailed description of the preferred embodiments.

| | |
|---|---|
| roller 10 | shaft 20 |
| roller 30 | shaft 40 |
| roller 50 | groove 51 |
| shaft 60 | groove 101 |
| contact area 102 | insertion passage 103 |

### BRIEF DESCRIPTION OF THE FIGURES

FIG. 1 illustrates a three-dimensional appearance of the first prior embodiment.

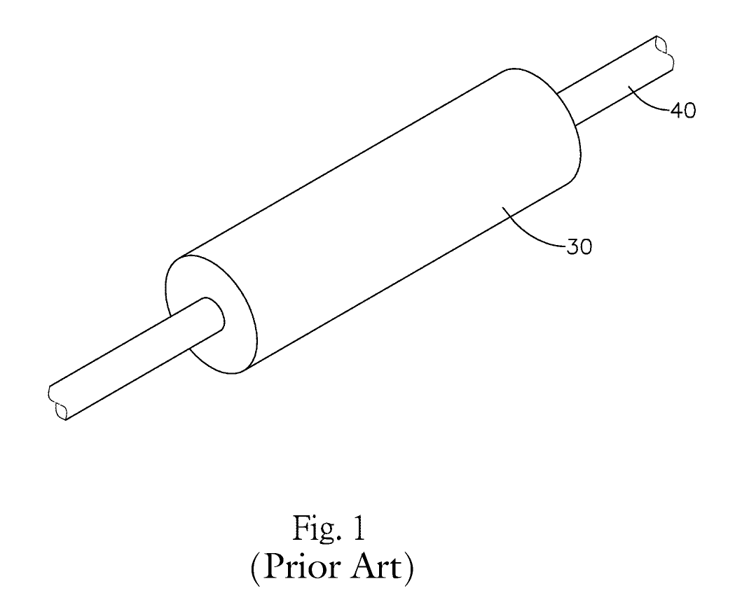

FIG. 2 illustrates a three-dimensional appearance of the second prior embodiment.

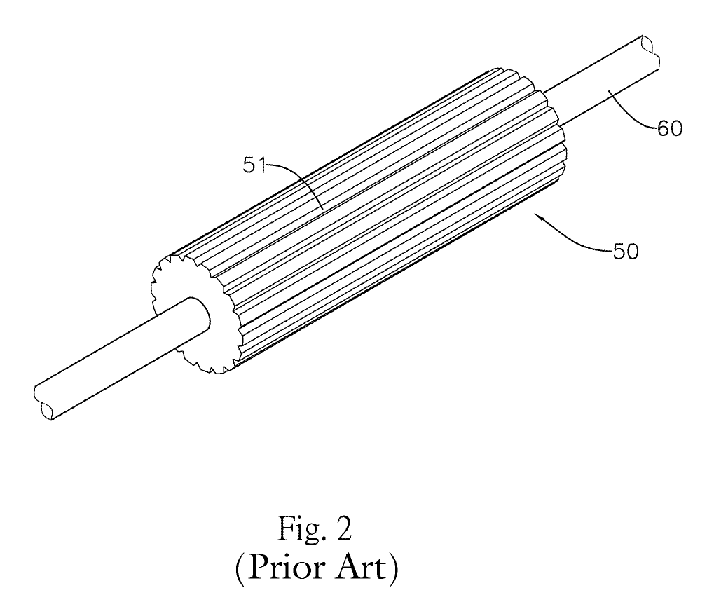

FIG. 3 illustrates a three-dimensional appearance of the present invention.

FIG. 4 illustrates a three-dimensional element decomposition view of the present invention.

FIG. 5 illustrates a three-dimensional appearance of another embodiment related to the present invention.

### DETAILED DESCRIPTION OF THE INVENTION

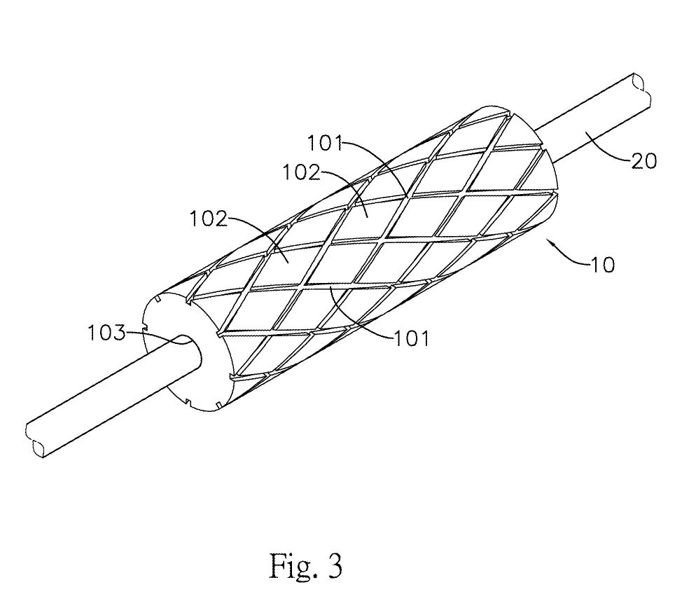

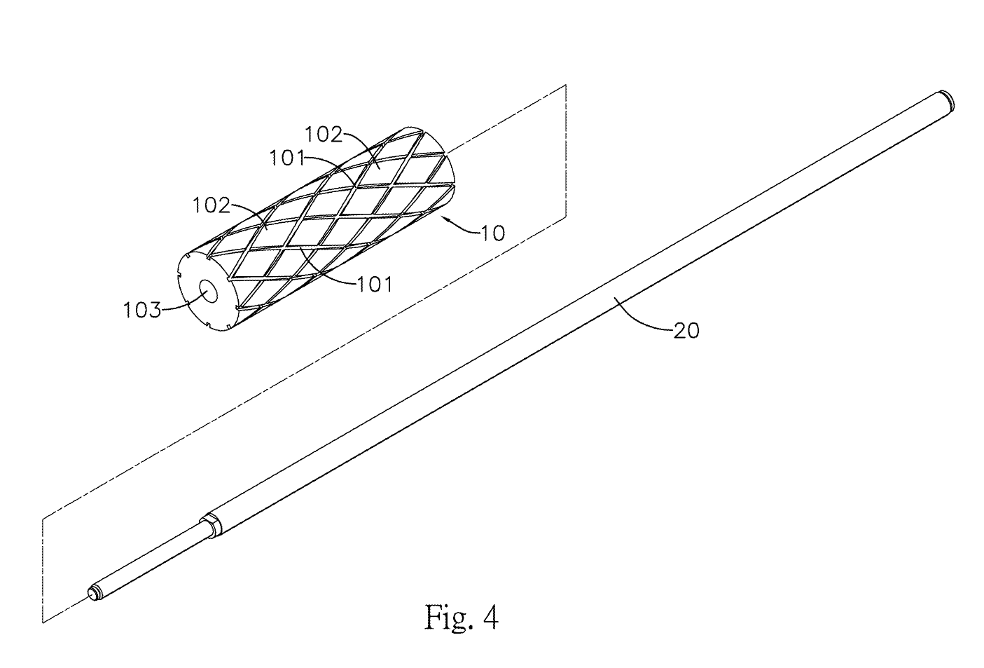

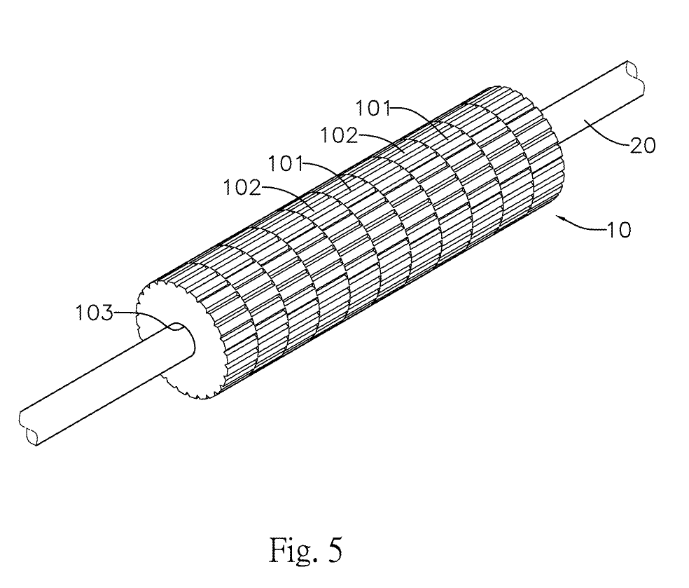

The present invention, please refer to FIG. 3 to FIG. 5, relates to a roller structure of a business machine which is essentially consisting of:

A roller 10, wherein a plurality of intersecting grooves 101 are provided on its friction surface to form a number of contact areas 102 simultaneously at the outer surface in the lateral direction along the roller 10 during the whole rotating process. The roller 10 structure can be made of an elastic rubber material.

A shaft 20, which drives the roller 10, is correspondingly installed through the insertion passage 103 located at the center of roller's cylindrical structure.

With the intersecting distribution of grooves 101, diamond-shaped contact areas 102 are created without any friction gaps to provide a better and more convenient function of a business machine. Above all, the present invention can provide a longer life expectancy of the roller parts.

Besides a net-like distribution of those near diamond-shaped contact area 102 on the outer surface of the roller 10, a plurality of grooves 101 around the circumference of the roller 10 could be randomly established section by section in a direction parallel to the shaft 20. The roller 10 can also be divided into a number of slices in accordance with the length of the grooves 101 before assembly of the whole roller's structure for the second embodiment of the present invention.

From the description above, it is apparent that the present invention provides a more efficient and useful roller structure of a business machine with multiple benefits which prior types could not achieve.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A roller structure of a business machine, comprising:
a roller, wherein the roller is essentially consisting of a plurality of grooves which are established on its outer friction surface to form a plurality of contact area simultaneously on the aforesaid surface in the lateral direction along the roller during any interval of the rotating process; and
a shaft, wherein the shaft is correspondingly installed through the insertion passage located at the center of its cylindrical structure of the roller.

2. A roller structure of a business machine according to claim 1, wherein a plurality of grooves are established concurrently as an intersecting and a netted distribution on the outer surface of the roller.

3. A roller structure of a business machine according to claim 1, wherein a plurality of grooves around the circumference of the roller are randomly established section by section in a direction parallel to the shaft on the outer surface of the roller.

4. A roller structure of a business machine according to claim 3, wherein the roller can be divided into a number of sliced rollers in accordance with the length of grooves randomly established section by section around the circumference of the roller.

5. A roller structure of a business machine according to claim 1, wherein the roller structure is made of rubber material.

6. A roller structure of a business machine according to claim 2, wherein the roller structure is made of rubber material.

7. A roller structure of a business machine according to claim 3, wherein the roller structure is made of rubber material.

8. A roller structure of a business machine according to claim 4, wherein the roller structure is made of rubber material.
